(19) United States
(12) Patent Application Publication
(10) Pub. No.: US 2013/0218628 A1
(43) Pub. Date: Aug. 22, 2013

(54) System And Method For Capital Budgeting And Cost Estimation

(71) Applicants: Raymond Dufresne, Salem, NH (US); Frank Paul Salamone, III, Sudbury, MA (US); Eamon Finbar Cournane, Somerville, MA (US); Laura Cook, Arlington, MA (US); Radhakrishnan Gopalakrishan, Natick, MA (US)

(72) Inventors: Raymond Dufresne, Salem, NH (US); Frank Paul Salamone, III, Sudbury, MA (US); Eamon Finbar Cournane, Somerville, MA (US); Laura Cook, Arlington, MA (US); Radhakrishnan Gopalakrishan, Natick, MA (US)

(21) Appl. No.: 13/840,521

(22) Filed: Mar. 15, 2013

Related U.S. Application Data
(63) Continuation-in-part of application No. 12/329,268, filed on Dec. 5, 2008.
(60) Provisional application No. 61/012,272, filed on Dec. 7, 2007.

(51) Int. Cl. G06Q 10/06

(52) U.S. Cl. CPC G06Q 10/06313
USPC 705/7.23

(57) ABSTRACT

A system for generating cost estimates and budgets for construction/maintenance projects for a property(s) allowing a user to select cost database from which to select cost data for the performance of an action item. The different databases may correspond to different geographic locations and include labor, materials and equipment costs for the selected location. The system further provides for presenting a hierarchical listing of cost line items with a cost associated with the item and searchable by description or an item identification number. The system still further allows for a user to click on an individual action item and obtain line item cost information relating to the selected action item.

### FIELD OF THE INVENTION

The invention relates to a system and method of cost estimation and budgeting for construction/maintenance projects for a property(s), allowing a user to select from among cost estimation databases and provide cost estimate information for projects, and to rank these projects to allocate budget within a defined timeline.

### BACKGROUND OF THE INVENTION

Organizations and companies that occupy and/or possess numerous real properties, often find it a challenge to organize, maintain, improve and modify those properties. Often, there are various competing interests and the funds available will not allow all the potential projects to be completed simultaneously or within, for example, a fiscal year. For instance, an organization (such as a school) may want to upgrade certain classrooms with new audio-visual equipment, however, the roof on the building may require immediate repair where failure to do so could result in collateral damage to the building. The organization must then determine which project(s) to complete, the priority that each project should have relative to the other identified projects, and how to allocate the available funds to complete these projects.

Most organizations develop their capital budgets by collecting data from each department (relating to, for example, various properties) and then try to rationalize the needs against the available funds. This is typically accomplished by considering each project to determine priority, cost and schedule. However, as each department has different priorities, this can lead to conflicts and delays in finalizing the budget. Additionally, this process can be very time-consuming when a relatively large number of properties are involved and perhaps many hundreds of projects need to be considered.

Another problem with current methods is that if a project is identified subsequent to the project consideration process described above, the newly identified project must be reviewed in light of all the projects on the list (or at least a large portion of the projects listed) to determine where the newly identified project ranks relative to the ones already on the list. This can be quite time-consuming and burdensome, especially after the original review process.

Still another problem with the current project consideration method is that, often, this method only concerns or addresses projects for the current year and not needs that may span years or could be important in the future.

Additional problems arise with current methods because the processes, and therefore the criteria for making the decisions, are not entirely transparent to review and oversight. This can make the process of receiving authorization to proceed with projects more difficult to obtain. If the decision-making process were more transparent, the budget presented for review and authorization would be more easily defensible. This would have the effect of streamlining the review and decision-making process.

### SUMMARY OF THE INVENTION

What is desired therefore is a system and method that generates a capital budget plan allowing for various projects to be identified, quantified and ranked relative to each other based on objective criteria.

It is further desired to provide a system and method that generates a capital budget plan, such that, after a list of various projects have been quantified and ranked relative to each other based on objective criteria, provides for adjustment to that list (based on the same objective criteria) when an additional project(s) is added to the list.

It is still further desired to provide a system and method that generates a capital budget plan for the identification, quantification and ranking of various potential projects based on objective criteria for the current fiscal year and for future fiscal years.

It is still further desired to provide a system and method that generates a capital budget plan allowing for various projects to be identified, quantified and ranked relative to each other based on objective criteria where the objective criteria allows for transparent review and oversight of the generated capital budget plan.

These and other objectives are achieved in one advantageous embodiment of the invention, by the provision of a Capital Budget Ranking Module (CBRM) that allows an organization to develop one or more sets of priorities to be applied to all the capital needs the organization may have. By using an objective model that looks across the entire organization, a more transparent and defensible budget can be created.

All the capital needs of the organization are rank-ordered as defined by the developed priorities to identify the most important capital needs. The mathematical approach, using pair-wide analysis, may be augmented by individuals within the organization to create an optimal budget.

Multiple budgets may be defined, as many organizations have more than one source of funding and different classes of capital assets that may need their own prioritization strategy. The multiple budget scenarios may further be compared to see the impact on the future condition of the portfolio due to different investment levels and help the organization define the appropriate level of funding. Based on the agreed-upon assigned priorities, a multi-year capital budget for capital funding may be produced that will achieve the organization's facility and business objectives.

While to this point the prioritization of performing certain actions has been primarily discussed, another concern for organizations is the cost involved with performing certain actions to determine which actions can be accomplished within, for example, a yearly budget. The cost estimation system includes a database of information that includes cost information associated with the performance of discrete actions and/or groups of actions. In one embodiment, the cost estimation system allows for multiple cost estimation sources to provide cost information, which may include labor, materials and equipment costs adjusted for the location of the facility. These multiple cost estimation sources could include separate costs listing to be viewed by a user, and could further include a cost estimate that is averaged across the multiple cost estimation sources. An example of multiple cost estimation sources could include, for example, RSMeans (a cost estimation database for the U.S.) and Building Cost Information Service (BCIS) of the Royal Institute of Chartered Surveyors (RICS) (a cost estimation database for the U.K.), which could provide cost estimates on a countrywide basis. The user could select which cost estimation source they desire based on the location of the project(s).

It is further understood that discrete cost line items could be identified by, for example, and item code, which could be searchable by a user to enhance searching capabilities. Still further, it is understood that costing information can be navigated by a user in various ways, including, for example, via an expandable cost line item navigation “tree” (e.g., a visual interface indicating which costs are associated with which cost categories) that allows a user could click on to view individual line item costs depicted on the “tree.” In one embodiment, the “tree” could comprise a hierarchical listing of costing information. This hierarchical listing could be provided in, for example, a first frame on a web page and when a particular line item is selected (clicked on by a user) line item cost information could then be presented in a second frame

Still further, the cost estimation system could provide for the user to see the cost associated with particular discrete actions, groups of actions, and/or individual cost line items based on geographic location or area. All of these various features allow for the user to get accurate cost estimation information associated with various projects based on their location.

In one embodiment, the system provides for a cost source location selector that can provide a listing of geographic areas (e.g., State by State in the United States), which when a particular state is clicked on expands to provide still further geographic listing within that selected geographic area (e.g., by County or by City, etc.). When a user clicks on the County or City, cost estimates for projects can be provided based on that selected geographic area.

The CBRM provides the user with ability to apply decision criteria to a set of assets, ultimately generating a multiyear budget. CBRM allows users to prioritize requirements based on the more traditional parameters including Facility Condition Index (FCI) and Action Year, and on any other asset or requirement parameter. Users can create multiple budget scenarios on the same asset portfolio, apply varying levels of funding based on straight annual funding, funding incremented by inflation or other factors, or funding as a percentage of replacement value.

By varying the prioritization of requirements based on a flexible decision process (for example prioritizing environmental or regulatory compliance requirements highest) a user can create multiyear budgets that are fine-tuned to the organizations changing condition or strategic goals. In each funding scenario, the overall effect of the budgetary expenditures on the asset FCI can be quickly determined.

Once the final budget scenario has been determined, each requirement in the budget may be identified and marked as part of the budget. The budgeting system includes some key features including: the ability to apply pair-wise decision processes to prioritize requirement and asset (building) parameters; provision of multiple funding options that are supported including specific annual funding, extrapolation funding (increase by a specific percentage each year), or funding as a percentage of replacement value of the portfolio; quick and efficient creation of projects based on requirements chosen in each budget, for all years; export of decision criteria, budget results, ranked requirements, and all data to, for example, Excel format, CSV, and PDF; and generation of reports allowing users to capture all ranked requirements sorted by region, campus, asset, or by other parameters important to the organization.

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The term “network” as used herein includes both networks and internetworks of all kinds, including the Internet, and is not limited to any particular network or inter-network.

The terms “first” and “second” are used to distinguish one element, set, data, object or thing from another, and are not used to designate relative position or arrangement in time.

The terms “coupled”, “coupled to”, and “coupled with” as used herein each mean a relationship between or among two or more devices, apparatus, files, programs, media, components, networks, systems, subsystems, and/or means, constituting any one or more of (a) a connection, whether direct or through one or more other devices, apparatus, files, programs, media, components, networks, systems, subsystems, or means, (b) a communications relationship, whether direct or through one or more other devices, apparatus, files, programs, media, components, networks, systems, subsystems, or means, and/or (c) a functional relationship in which the operation of any one or more devices, apparatus, files, programs, media, components, networks, systems, subsystems, or means depends, in whole or in part, on the operation of any one or more others thereof.

It should be noted that the term “facility” and “facilities” as used herein are intended to include real estate and any improvements made thereon including, for example but not limited to, building(s), infrastructure associated with the building(s) whether inside or outside of the buildings, roads, pathways, outdoors recreational areas and systems associated therewith.

The terms “Facility Condition Index” or “(FCI)” as used herein is a grading system used to rate the condition of a facility with a rating of 0.0 equating to a facility in perfect condition and ranging to a rating of 1.0 where the cost to repair equals the cost to replace the facility.

In one advantageous embodiment a method for generating a capital budgeting plan is provided comprising the steps of storing real property information on a computer having a storage, the real property information including data relating to the current status and configuration of the real property and forming a set of rules providing a relative ranking of project criteria for the real property, the project criteria selected from the group consisting of: FCI, project category, project system and combinations thereof. The method further comprises the steps of inputting project information into the computer relating to real property projects for the real property and ranking the real property projects based on the real property information and the set of rules. The method further includes the steps of generating a list of real property projects based on the ranking and displaying the ranked list to a user.

In another advantageous embodiment a system for generating a capital budgeting plan for real property is provided comprising a computer having software executing thereon for generating a capital budgeting plan and a storage accessible by the computer. The system further includes real property information stored on the storage, the real property information including data relating to the current status and configuration of the real property. The system still further includes a set of rules stored on the storage, the set of rules providing a relative ranking of project criteria for the real property, the project criteria selected from the group consisting of: property type, FCI, project category and combinations thereof. The system also includes project information entered into the software program, the project information relating to real property projects for the real property. The system is provided such that the software ranking the real property projects is based on the real property information and the set of rules. The system further comprises a list of real property projects generated by the software, where the list is based on the ranking and a display for displaying the ranked list to a user.

In still another advantageous embodiment a system for generating a capital budgeting plan for real property is provided comprising: a computer having software executing thereon for generating a capital budgeting plan; and a storage accessible by the computer. The system further includes software executing on the computer and providing a cost estimator for a user such that user is provided with cost estimates for an action. The cost estimator includes at least two cost databases, each database including cost information for performing an action item. The system is provided such that at least one of the at least two databases is selectable such that cost information is gather from the selected database to provide cost information for the action item.

Other objects of the invention and its particular features and advantages will become more apparent from consideration of the following drawings and accompanying detailed description.

### BRIEF DESCRIPTION OF THE DRAWINGS

FIG. 1 is a screen shot of Ranking Strategies definitions.

FIG. 2 is a screen shot of the Overall Ranking according to FIG. 1.

FIG. 3 is a screen shot defining Category and illustrating a relative ranking of Energy versus the various Category listings and Environmental versus the various Category listings according to FIG. 1.

FIG. 4 is a screen shot of the Overview illustrating the relative rankings of the various selected definitions according to FIG. 1.

FIG. 5 is a screen shot of Budget Scenarios based on the selected Ranking Strategies according to FIG. 1.

FIG. 6 is a screen shot illustrating graphical results for the Budget and Impact on FCI according to FIG. 5.

FIG. 7 is a screen shot of the Ranked List of Requirements according to FIG. 1.

FIG. 8 is a report ranking the List of Requirements according to FIG. 7.

FIG. 9 is a report illustrating the graphical results for the Budget and Impact on FCI according to FIG. 6.

FIG. 10 is a screen shot illustrating Requirements costs extending over a multi-year budget scenario.

FIG. 11 is a screen shot of the Tag Requirements for Project Creation.

FIGS. 12-14 variously illustrate screen shots for Tag Requirements including specific asset and requirements information and an adjusted Ranked List showing Overrides.

FIG. 15 is block diagram according to FIG. 1.

FIG. 16 is a screen shot of the system according to FIG. 15 illustrating an action record with line items inserted from the cost estimator.

FIG. 17 is a screen shot of a hierarchical listing of geographic locations for a cost source which may be selected for an asset or group of assets to localized costs in actions according to FIG. 16.

FIG. 18 is a screen shot of the cost estimator according to FIG. 16 showing cost source selection (1), various cost categories (2), cost line items within a cost category (3), and line item details (4).

FIG. 19 is a screen shot of the cost estimator according to FIG. 16 showing multiple cost estimation sources (B) and the configuration of the availability of those cost sources in the system (A).

FIG. 20 is a screen shot of the cost estimator according to FIG. 20 in which additional details for specific line item costs are listed.

### DETAILED DESCRIPTION OF THE INVENTION

Referring now to the drawings, wherein like reference numerals designate corresponding structure throughout the views.

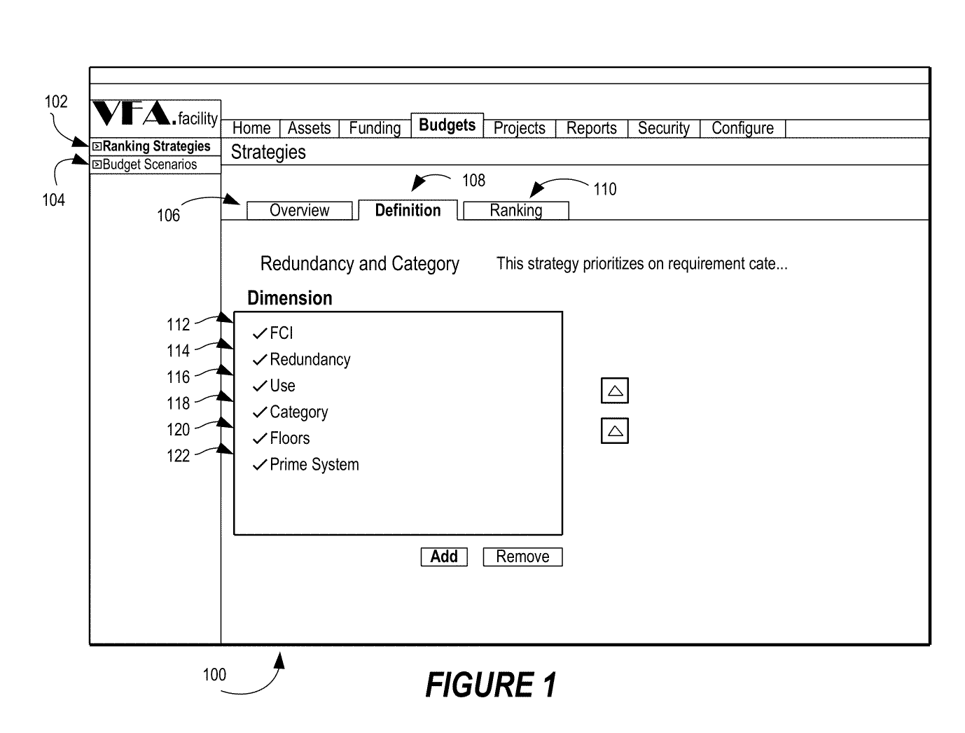

FIG. 1 is a screen shot illustrating system 100, which in this embodiment includes two tabs: Ranking Strategies 102 and Budget Scenarios 104. In FIG. 1, the Rankings Strategies tab is shown highlighted, which brings up a list of tabs including, for example, Overview 106, Definition 108 and Ranking 110.

A list of various project criteria, which in this example, includes FCI 112, Redundancy 114, Use 116, Category 118, Floors 120 and Prime System 122. It should be noted that the present project criteria illustrated is provided only as an example and may include additional project criteria or fewer based on the requirements of the various real property and the organization preparing the budget plan.

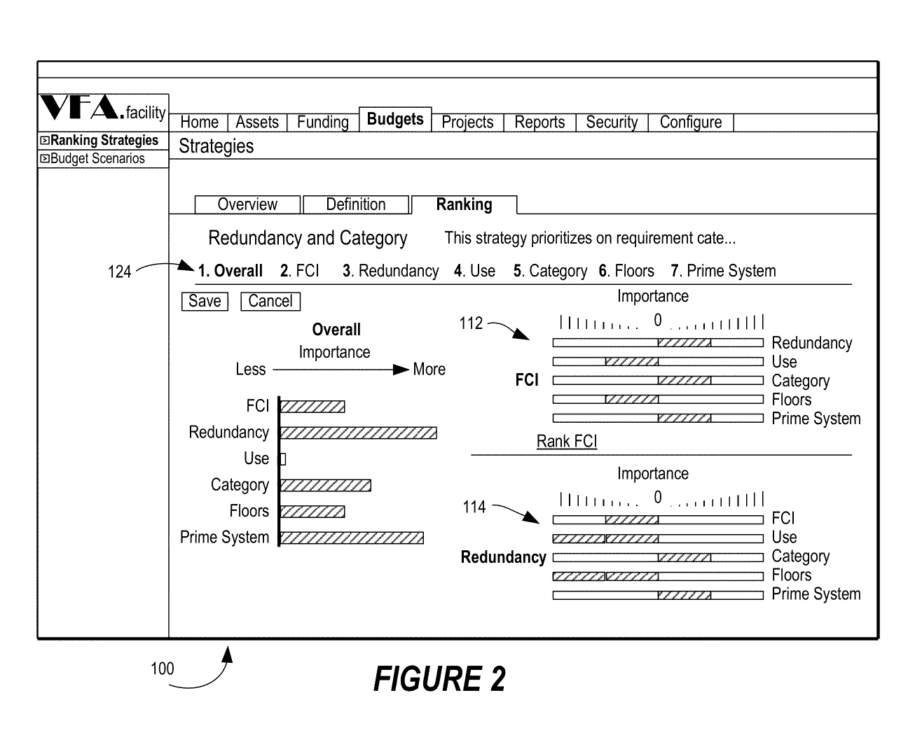

FIG. 2 is another screen shot illustrating the Overall ranking 124 of the various project criteria shown in FIG. 1. In this example, a user has the option to provide relative rankings of the various project criteria relative to each other for the generation of a set of rules against which the system will make decisions. For example, FCI 112 is a project criteria that was initially selected. The user has the option to rank the relative importance of FCI 112 versus all the other project criteria, which in this case includes Redundancy 114, Use 116, Category 118, Floors 120 and Prime System 122.

Additionally, the user has the option to provide relative rankings of each of the selected project criteria relative to each other, which is illustrated in FIG. 2 where a further one-to-one ranking of Redundancy 114 is ranked against each of the other project criteria. While only FCI 112 and Redundancy 114 are illustrated in FIG. 2, it is understood that each of the project criteria may be ranked directly against each of the other project criteria such that all criteria are directly ranked against each other. This direct ranking is used by the system in generating a Set of Rules used to generate a Ranked List of requirements.

It can be seen in FIG. 2 from the Overall ranking of the various project criteria, that Redundancy 114 is ranked higher than all of the other project criteria, while Prime System 122 is the next highest ranked and so on.

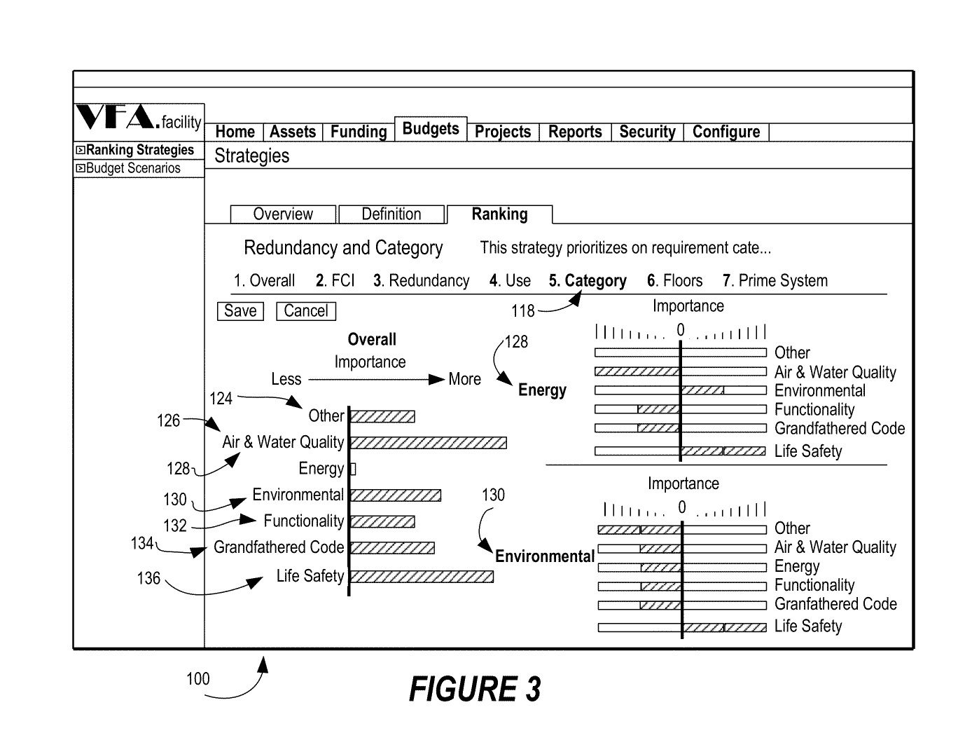

Referring now to FIG. 3, an illustration of one of the project criteria (e.g. Category 118) is shown. In this example, Category 118 comprises the following possible values: Other 124, Air and Water Quality 126, Energy 128, Environmental 130, Functionality 132, Grandfathered Code 134 and Life Safety 136. Accordingly, a user has the option to quantify the importance of each the various criteria in Category 118. As can be seen from FIG. 3, the user has the option to rank each criteria versus each of the other criteria in Category 118. For example, Energy 128 is ranked directly against each of the other criteria in Category 118 and Environmental is ranked directly against each of the other criteria. While Energy 128 and Environmental 130 are illustrated, it should be noted that each criteria may be directly ranked against other criteria in Category 118.

This allows the user to create rules on a global level so that the user can specify which criteria is more important to the user (or organization) relative to the other categories. For example, in the screen shot illustrated, the user has selected Life Safety 136 as the most important criteria to be maintained (replaced/improved/etc.), followed by Environmental 130 and Energy 128. This allows the user complete control in creating a Set of Rules that reflects the specific ideals or mission plan of the organization.

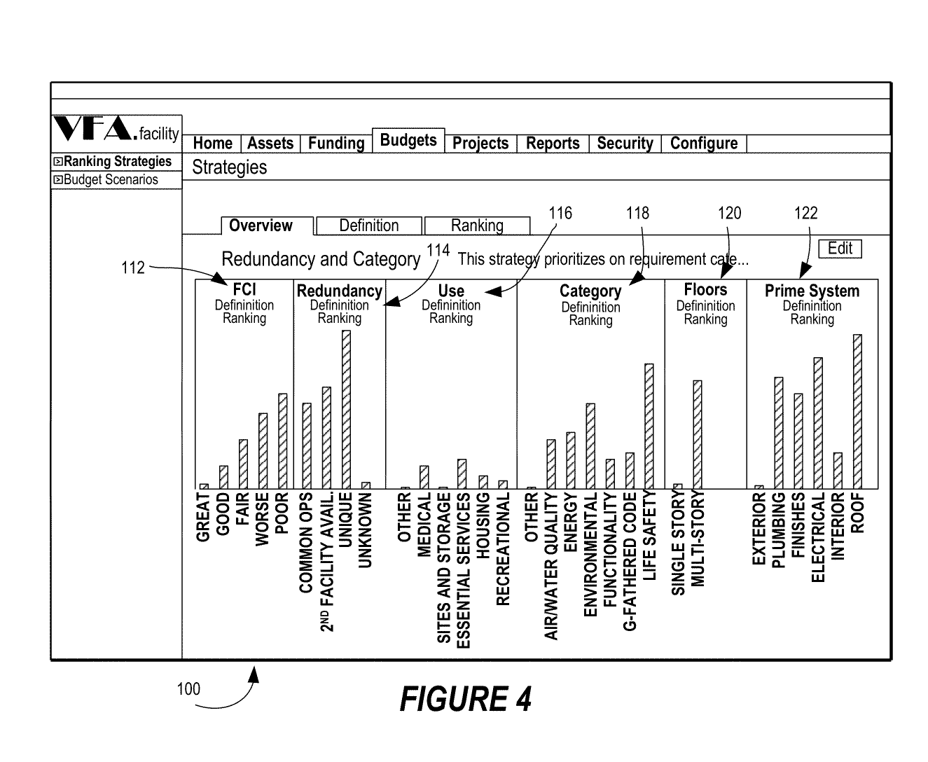

Referring now to FIG. 4, an Overview of all the various project criteria is illustrated. For clarity, a description of each of the various project criteria will be provided, however, it should be noted that virtually any type of project criteria may be used and the particular criteria shown is for illustration purposes only and should not limit the scope of the invention.

FCI 112 is provided with five possible values including: Great, Good, Fair, Worse and Poor. FCI is a number that is assigned to a building that provides an overall estimated rank for the current condition of the building. Therefore, while FCI 112 is divided into five possible values, it is contemplated that any number of values may be used, or simply the FCI number itself could be used. In this example, the lower the FCI ranking (e.g. the poorer condition the building is in) the higher in importance each project associated with that building is assigned. For example, if a Life Safety system in two different buildings is in need of repair/replacement, the Life Safety system in the building with the lower FCI will be ranked higher on the Ranked List that is eventually generated by the system 100.

The next project criteria listed is Redundancy 114, which is provided with four possible values including: Common Operations, Secondary Facility Available, Unique and Other. In this way, the user can rank the relative importance of projects in various facilities based on whether the facility is relatively common facility or a unique facility for the organization. For example, it could be that a city has a number of projects to complete over the course of a fiscal year. One of the projects is in one of the city's eight fire stations and the other is in the city's only waste water treatment plant. If the operations at one of the city's fire stations were interrupted, it is understood that seven other facilities are on-line so-to-speak to handle the temporarily interrupted operations of the eighth facility. However, if the operations of the unique facility were interrupted, there is absolutely no other facility available to perform the function. Accordingly, real properties that are designated “unique” are given the highest priority so the interruption in services are avoided.

The next project criteria listed is Use 116, which is provided with six possible values including: Other, Medical, Sites and Storage, Essential Services, Housing and Recreational. This allows the user to provide a relative ranking to the importance of the use a particular real property is put to. As can be seen in this particular example, the use a particular real property is put to is ranked relatively lower in importance than, for example, the redundancy classification of the real property. Again, while six criteria are listed under Use 116, it is contemplated that virtually any number of criteria may be specified.

The next project criteria listed is Category 118, which is provided with possible values previously described in connection with FIG. 3.

The next project criteria listed is Floors 120, which is provided with two possible values including: Single Story and Multi-Story. Again, as stated above, virtually any number of criteria may be included such that the Set of Rules generated by system 100 will reflect the goals and mission of the organization.

Finally, the last project criteria listed is Prime System 122, which is provided with possible values including: Exterior, Plumbing, Finishes, Electrical, Interior and Roof. This again allows the user to provide a relative ranking for the importance of various criteria listed in Prime System 122. For example, it can be seen that Roof projects are provided with greater importance than, for example, Finishes. In this particular example, the user may be concerned about collateral damage to the building if the roof leaks and therefore has provided a higher importance to such projects. However, any number of criteria may by listed or provided under this listing, such as, for example but not limited to, HVAC, communications systems including voice and data, etc.

The pair wise ranking of each criteria against other criteria allows for the relative ranking of various criteria versus every other criteria. The selected criteria and the relative importance of each criteria comprises the Set of Rules generated by the user and used by the system to allocate values to various projects.

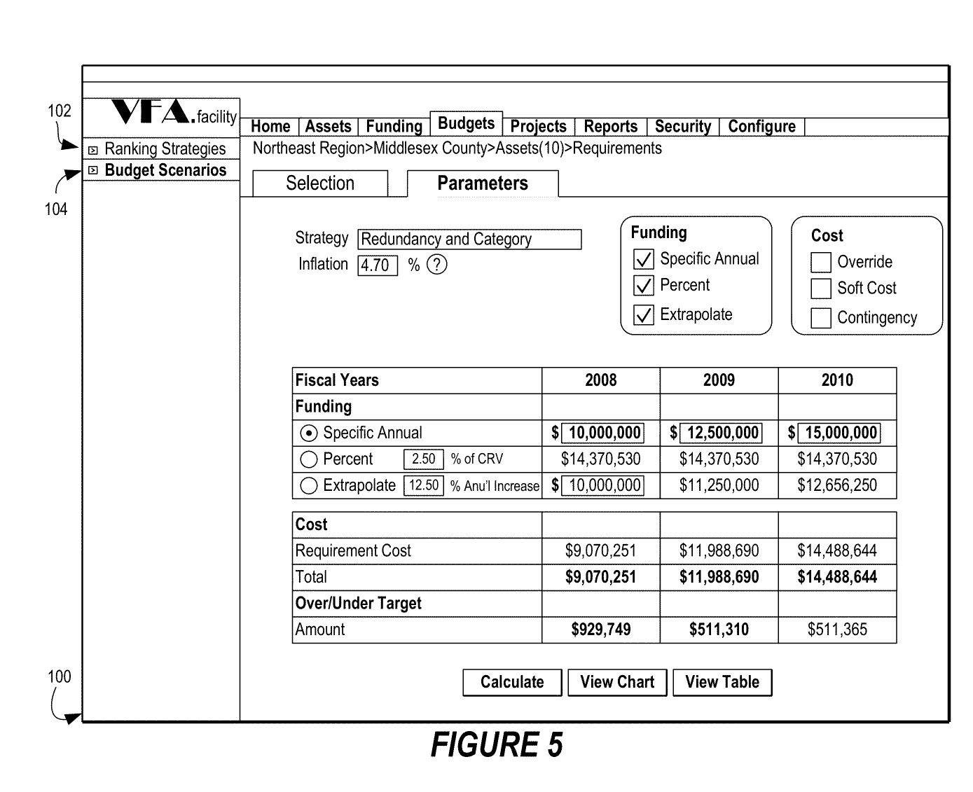

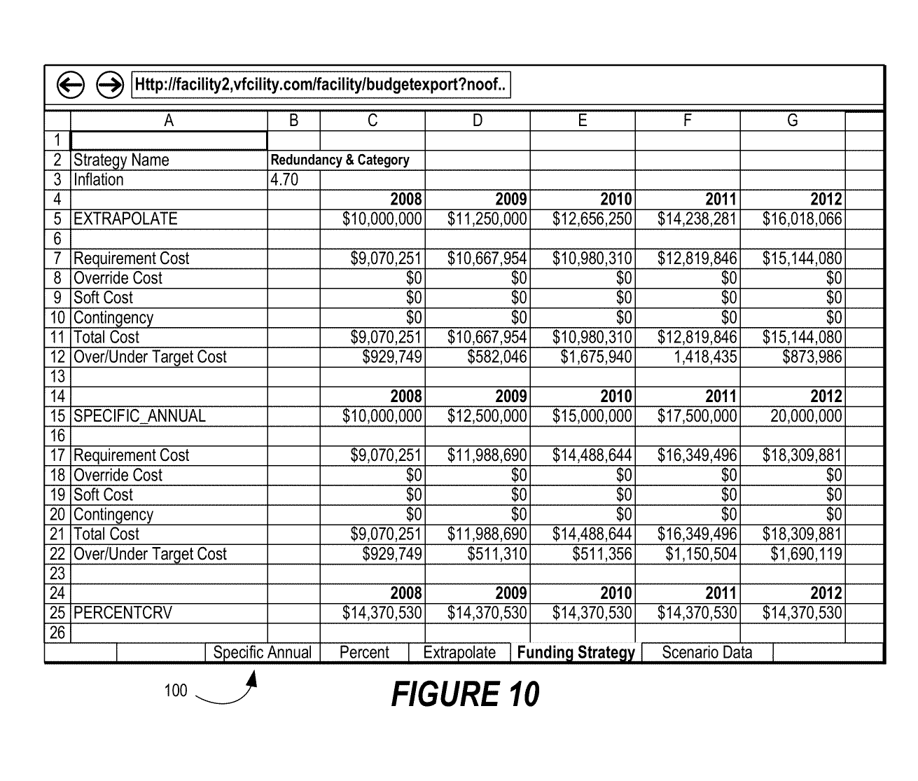

As can be seen in FIGS. 5 and 10, the Budget Scenarios 104 tab has been selected now that the Ranking Strategies 102 has been determined. Here the user is provided wide latitude for allocating a budget for a project. For example, a user may allocate a specific amount of funding per year for a project, or may provide a percent of the total project cost per year, or extrapolate a percent annual increase. This allows the user to see various funding scenarios so as to be able to get an accurate picture of project costs and to allocate and schedule appropriate funds.

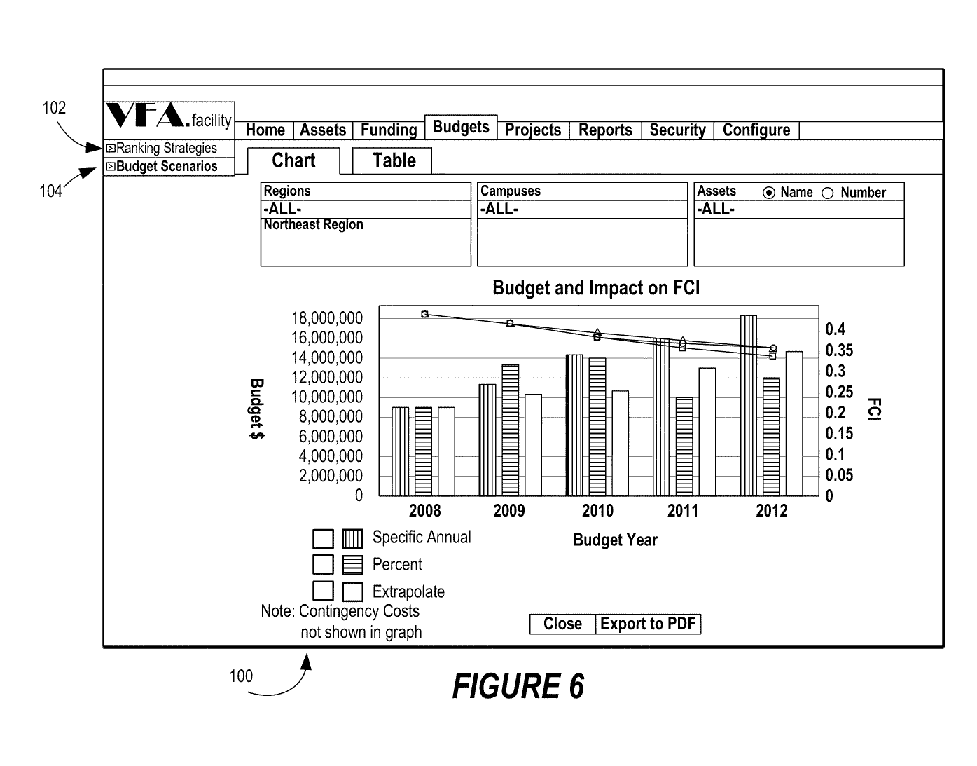

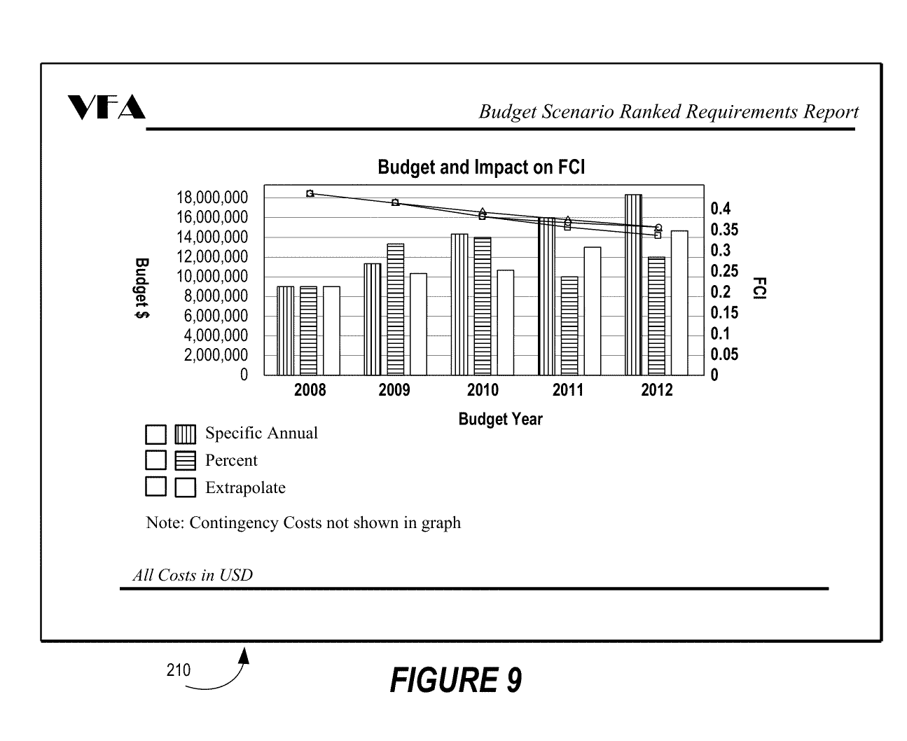

FIG. 6 is a screen shot illustrating the allocated funding for a particular real property and the effect of the particular fund allocation to the building FCI. This can be shown on a year to year basis with the particular funding for each building listed and the FCI for each building shown over the course of a number of years. This is provided as graphical information for the user, which allows the user to immediately see how funding decisions will affect each building over time. FIG. 9 illustrates a report 210 that may be generated by system 100 depicting the information provided, for example, in FIG. 6.

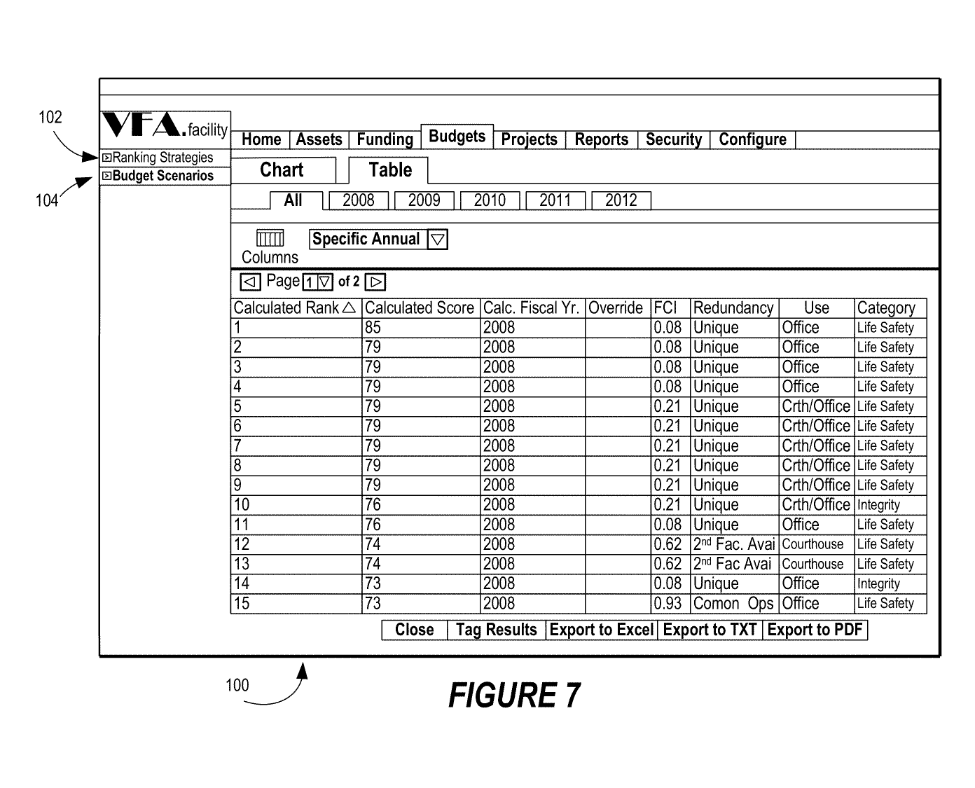

Referring to FIG. 7 a screen shot of a Ranked List of requirements is illustrated. For example, various requirements (projects) are listed in a ranked order extending from one to number fifteen illustrated in the particular screen shot. The highest ranked requirement received a calculated score of eighty-five (85). The various criteria are listed including, for example, the FCI listed as “0.08”, the redundancy listed as “unique”, the use listed as “office” and the category listed as “life safety.”

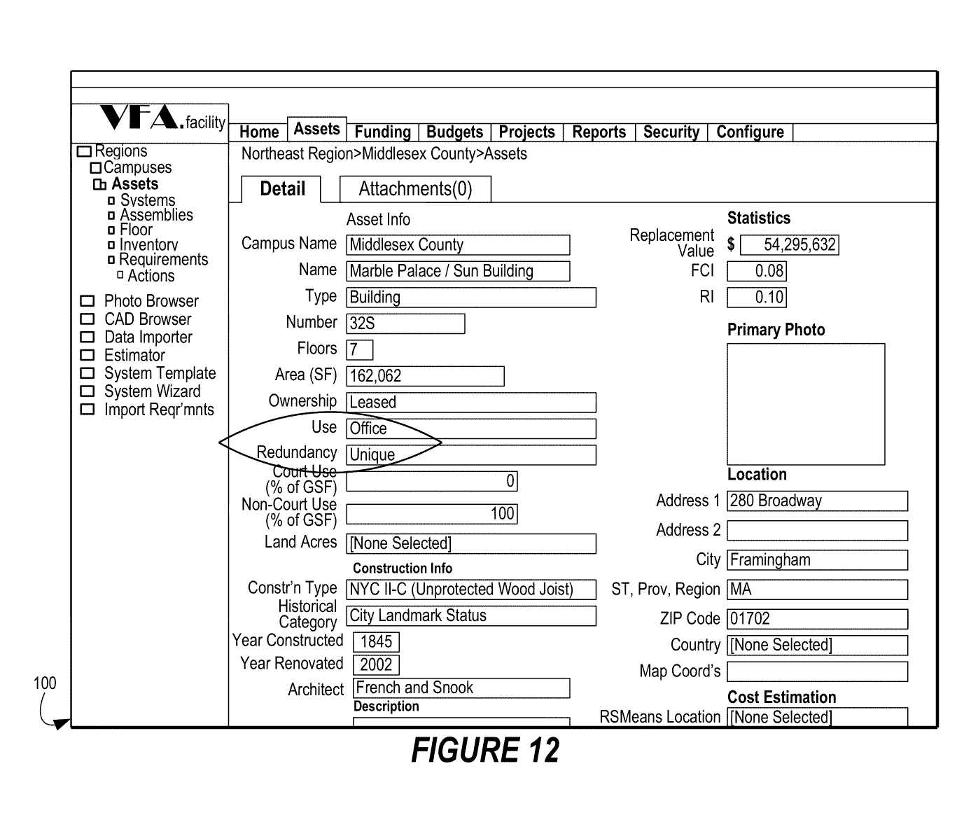

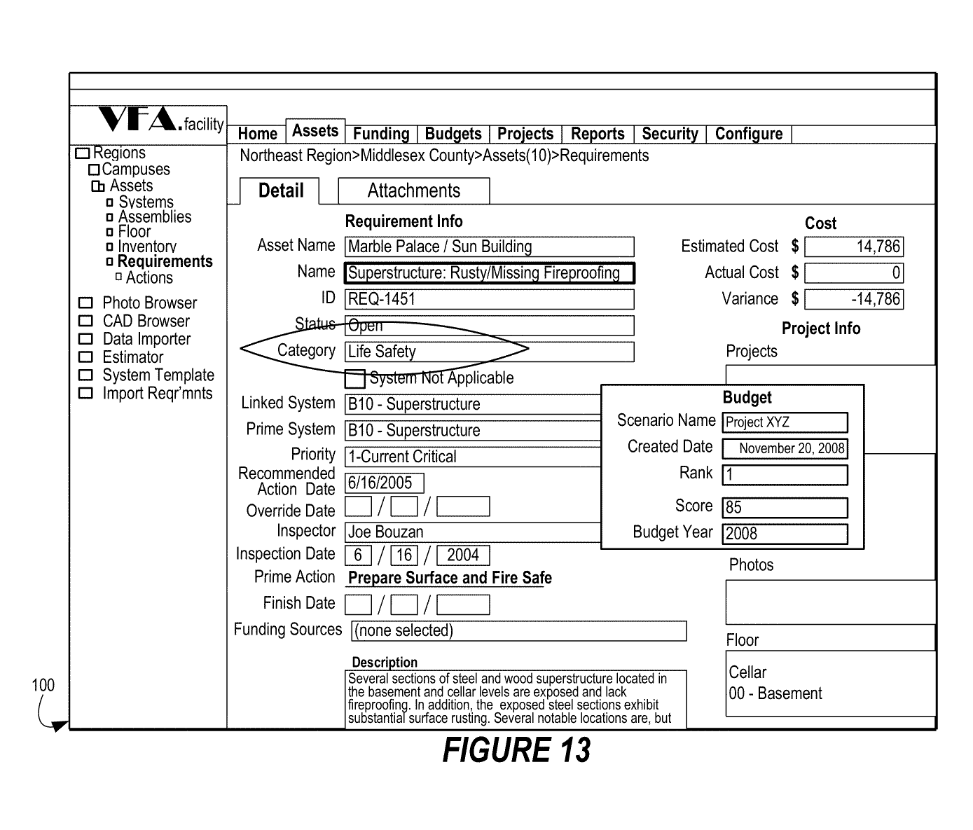

Accordingly, to generate the Ranked List of requirements, the system 100 will receive real property information data relating to the current status and configuration of the real property. This is shown, for example, in FIGS. 12 and 13 including the type of real property, the location, the classification of the real property and so on. The real property information may be quite detailed and include the exact specification for the building and the building systems with information relating to the current status of those systems. For example, this information is used to determine what projects need to be ranked.

Once the real property information has been input into the system 100, the user then determines the Set of Rules the system 100 will apply to the various requirements or projects that are identified. The process of determining the Set of Rules has been described in connection with FIGS. 2-6 relating to the setting of Ranking Strategies.

Once the real property information is supplied to system 100 and the Set of Rules is set by the user, the system 100 may then generate the Ranked List of requirements as illustrated in FIG. 7. The Ranked List may further list the criteria that were used in generating the calculated score.

It should be noted that, while various functions and methods have been described and presented in a sequence of steps, the sequence has been provided merely as an illustration of one advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions described herein.

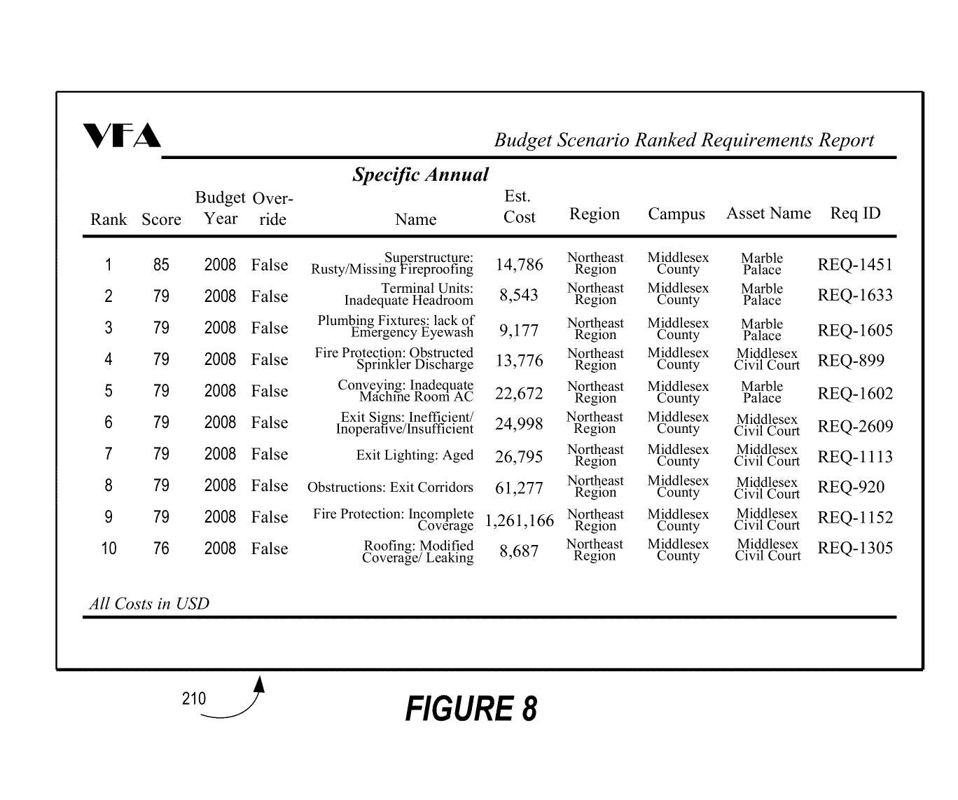

Referring now to FIG. 8, a Budget Scenario Ranked Requirements Report is provided that includes a ranking for each requirement (or project) and further includes a listing of the budget year, a name of the project (may include a descriptive name), an estimated cost for the project, and various other information useful to the user. Also listed on the Budget Scenario Ranked Requirements Report is a listing of whether an Override is present for the project.

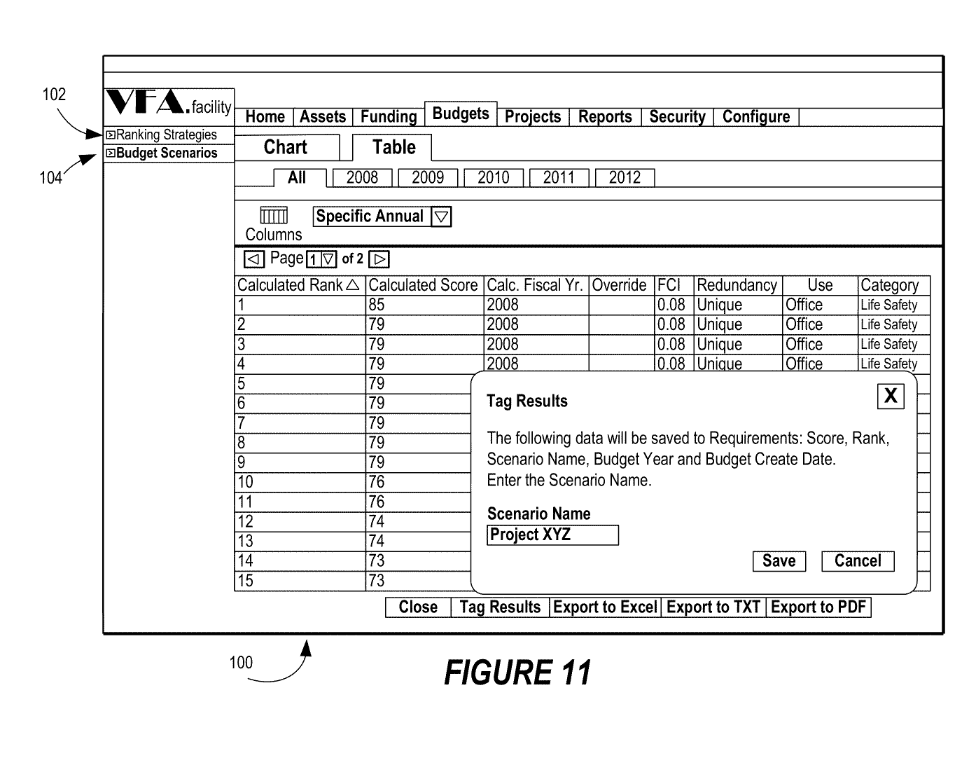

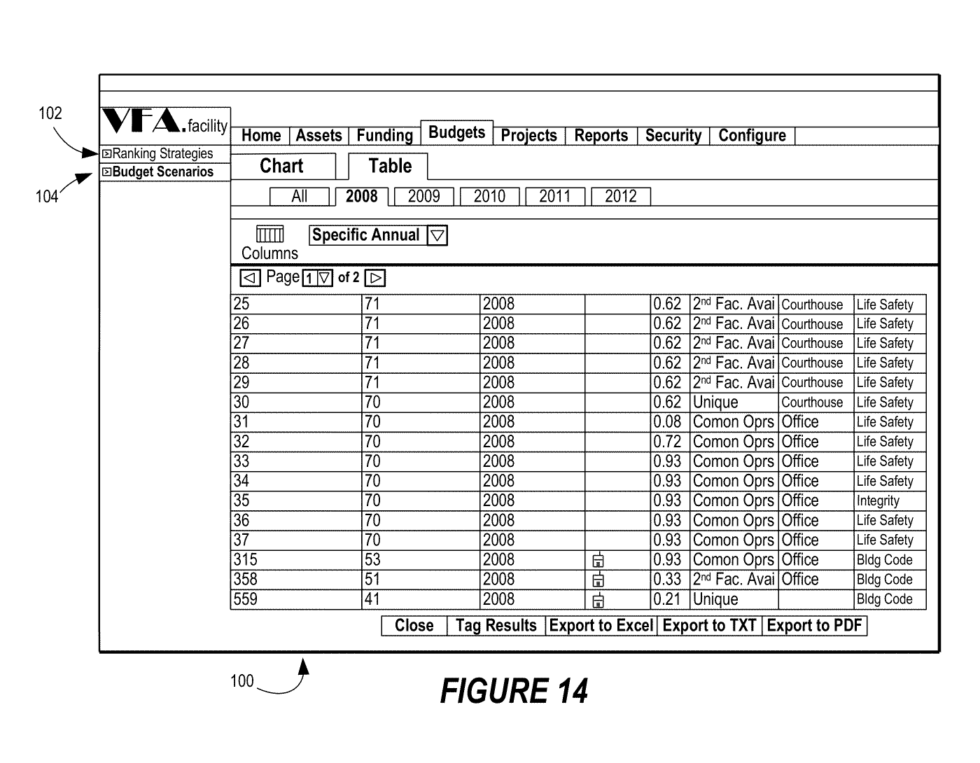

Referring to FIG. 11, it can be seen that the user is allowed to tag various requirements (projects) with information and/or data. This may allow the project to be ranked out of order such as is depicted in FIG. 14. This allows the system to apply the Set of Rules to the real property information to generate the Ranked List, but also allows the user to specify particular requirement (projects) to be completed earlier (e.g. within a fiscal year) rather than having to wait a number of years based on the calculated score. As can be seen in FIG. 14, at the bottom of the list the calculated rank of the projects ends at thirty-seven (37) and then jumps to three hundred fifteen (315). The system 100 will determine how many of the requirements on the Ranked List can be completed in the fiscal year depending upon the available funds. In this case, the system included a number of lower ranked projects in the fiscal year funding as these projects were tagged meaning an override was placed on the ranking thereby forcing these projects into the current year queue to be completed ahead of higher ranked projects allowing complete control over the process.

It can be seen from the above-described system that an objective, transparent and defensible Ranked List of requirements can be created for review and approval. The Ranked List will be generated on objective criteria that correspond to the organizations objectives and mission. Rather that providing a list including subjective analysis, the Ranked List generated by the system provides a global Set of Rules that is applied across the board to all projects. This allows for review of the ranked projects in a fair and objective manner, which provides a higher comfort level to those performing the review and a more efficient review process.

Additionally, unlike known systems, the Ranked List can quickly and easily be adjusted and a new report generated when additional requirements (projects) are identified. All that is necessary is to provide the real property information and the system will apply the Set of Rules to the new information generating a new Ranked List of requirements. Compared to known systems, this saves a tremendous amount of time and energy, while quickly providing a new Ranked List for review and approval. The result is a highly repeatable system that applies objective rules to all projects providing reviewers a high level of confidence in the relative ranking of various projects. The system further allows for multi-year budgets to be generated and funding to be allocated as desired. The final Ranked List of requirements can be used, once approved, to generate work orders, thereby saving additional time and money.

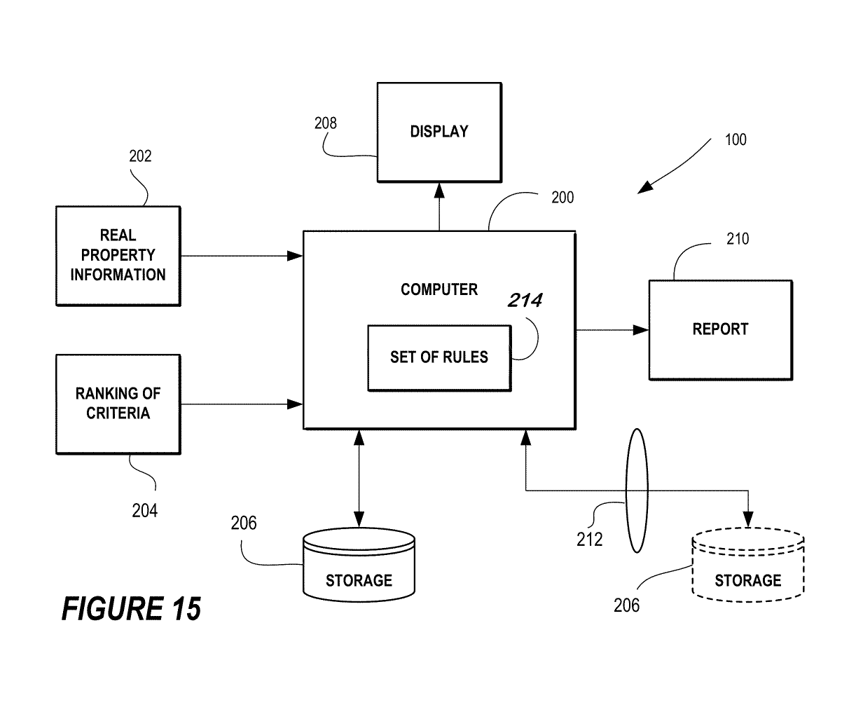

FIG. 15 is a block diagram depicting system 100, which in this embodiment includes computer 200, real property information 202, a Set of Rules 204, a storage 206, a display 208 and a report 210.

The real property information 202 may include any of the information as previously described relating to a particular real property. The ranking of criteria and of the possible values within each criterion 204 is performed by the user as previously described to generate a Set of Rules 214. Both the real property information 202 and the Set of Rules 214 may be stored in storage 206, which is accessible by computer 202. Storage 206 may be a local storage device or alternatively a remote storage device (shown in dashed line) that is accessible via, for example, a network connection 212 such as the Internet.

The display 208 may comprise virtually any type of display for inputting and displaying various information to the user. Additionally, the report 210 may comprise any of the reports previously described including, but not limited to, a Ranked List of requirements, a Budget Scenario Ranked Requirements Report, etc.

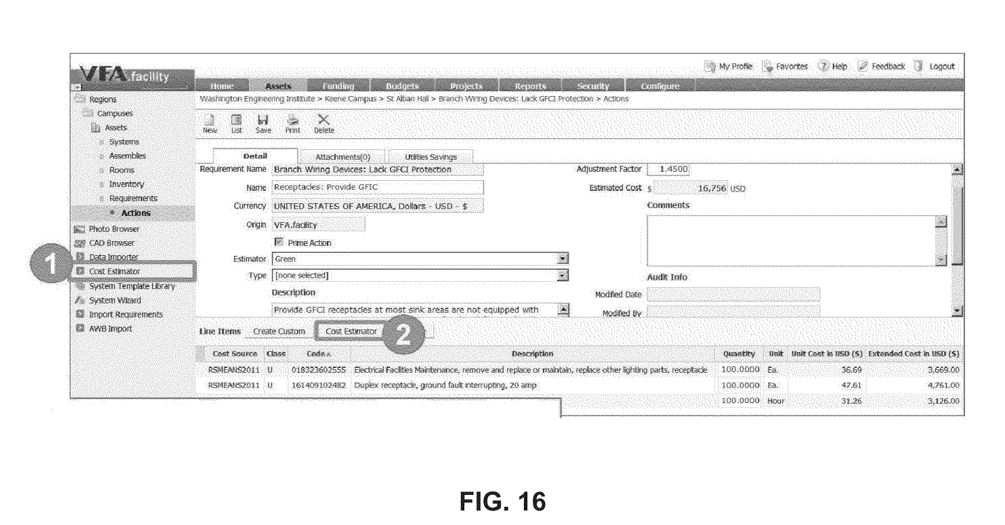

Referring now to FIG. 16-20, various screen shots are depicted illustrating features of the system for capital budgeting including the cost estimator. For example, FIG. 16 is a screen shot of the cost estimator feature where the facility has been identified and an action item (in this case, “Receptacles: Provide GFCI”) is listed along with a cost for performing the action item (in this case the estimated cost is listed as “16,756 USD”). As can be seen at the bottom of the screen shot, the cost per receptacle for labor and materials are shown and the quantity is also shown providing a breakdown of the various costs.

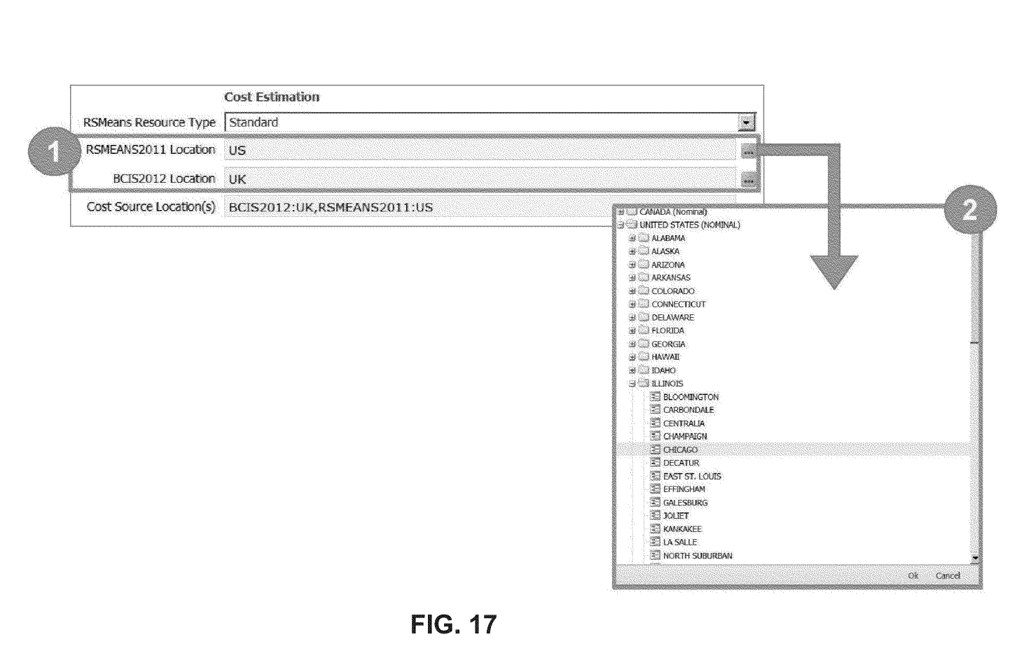

FIG. 17 is a screen shot showing a hierarchical listing of geographic locations. In this example, the user may select from among at least two databases of cost information (the “US” or the “UK” databases). In the example shown, the user has selected the “US” database and is provided with a hierarchical listing of geographic locations associated with the “US” database (in this example, a listing of various States in the United States). Once the user has selected a particular State (in this example, the user selected the State of Illinois) a further hierarchical listing of geographic locations is presented (in this example, a listing of various cities in Illinois). The cost estimator will adjust the cost for the action item based on the selected geographic location associated with the facility where the action item is to be performed. This would include, for example, the labor costs, the materials costs, permitting costs, etc.

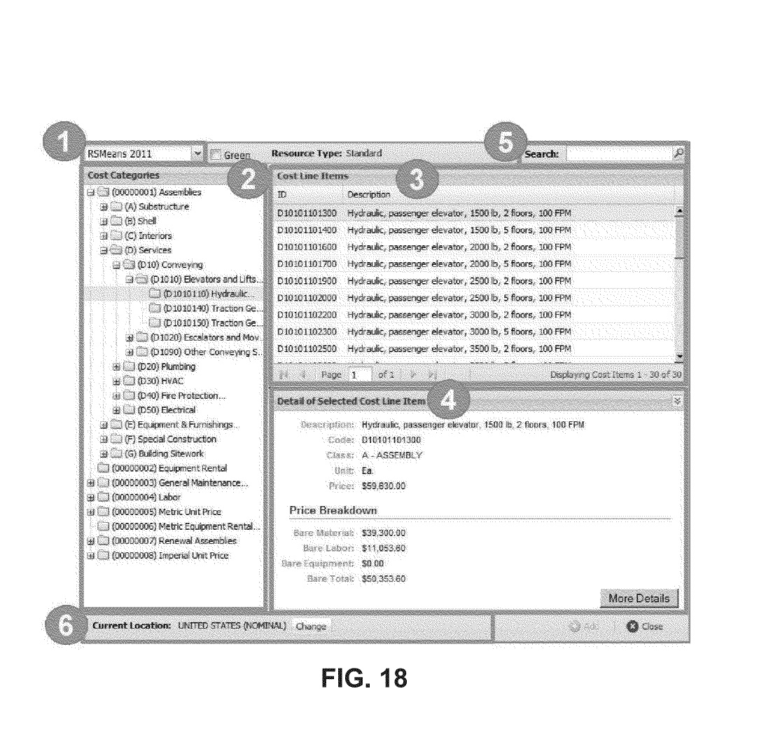

FIG. 18 is a screen shot of the cost estimator. In this screen shot, a hierarchical listing is provided in a first frame on a web page and when a particular line item is selected (e.g., clicked on by a user) line item cost information is presented in a second frame.

The example illustrated in FIG. 18 is utilizing the RSMeans database to provide cost information for the estimation of costs for an action item. For example, a first tier of information is provided in the first frame labeled “Cost Categories.” In the example provided, the category “Assemblies” has been selected and the user has drilled down in the “Assemblies” category via “Services”, then “Conveying”, then “Elevators and Lifts”, then “Hydraulic.” As can be seen from FIG. 18, additional information relating to the selection “Hydraulic” in the first frame is shown in a second frame showing both an ID number and a description for each hydraulic elevator. Also shown in FIG. 18, the first hydraulic elevator in the second frame has been selected and line item cost information/details is shown in a third frame providing among other information, a price breakdown for the selected hydraulic passenger elevator. In this manner, a user can quickly and easily drill down in a database to see cost information and even line item cost details associated with an action item or a system in the facility.

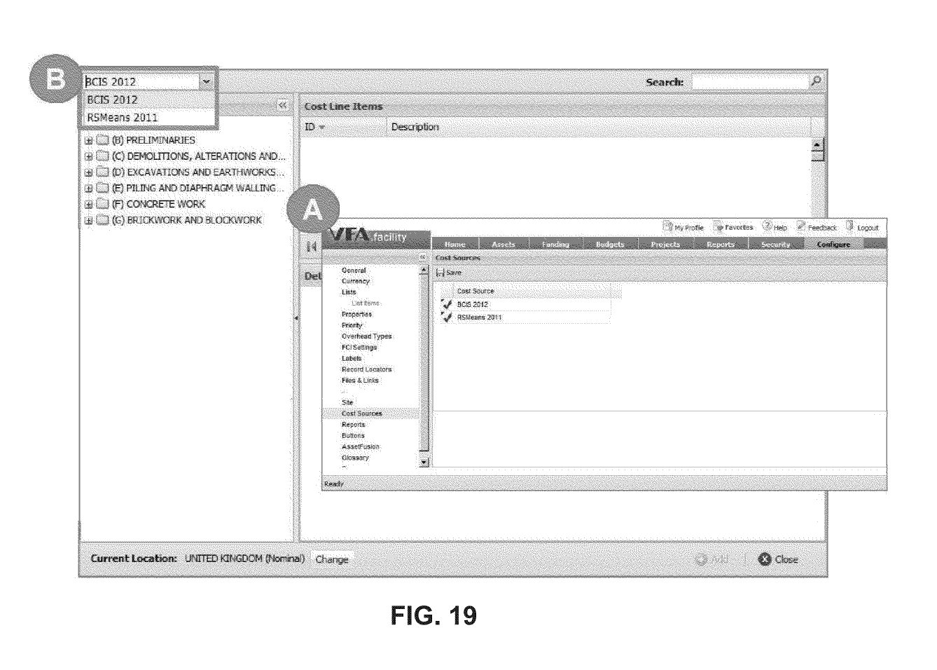

FIG. 19 is a screen shot of the cost estimator showing that a user may select from among multiple cost estimation sources. In this example, the two cost estimation sources are RSMeans (e.g., a cost estimation database for the U.S. and Canada) and BCIS (e.g., a cost estimation database for the U.K.). While only two cost estimation sources are shown in this example, it should be understood that any number of cost estimation sources may be utilized for various geographic locations. Additionally, it is not necessary to select only one cost estimation source as multiple cost estimation sources may be available for the same geographic area. In this case, a user could select more than one cost estimation source and the cost information provided to the user could be sorted individually by source (e.g., two different cost estimates for the same action item listed by source); or the system could provide an average of the various cost estimation sources.

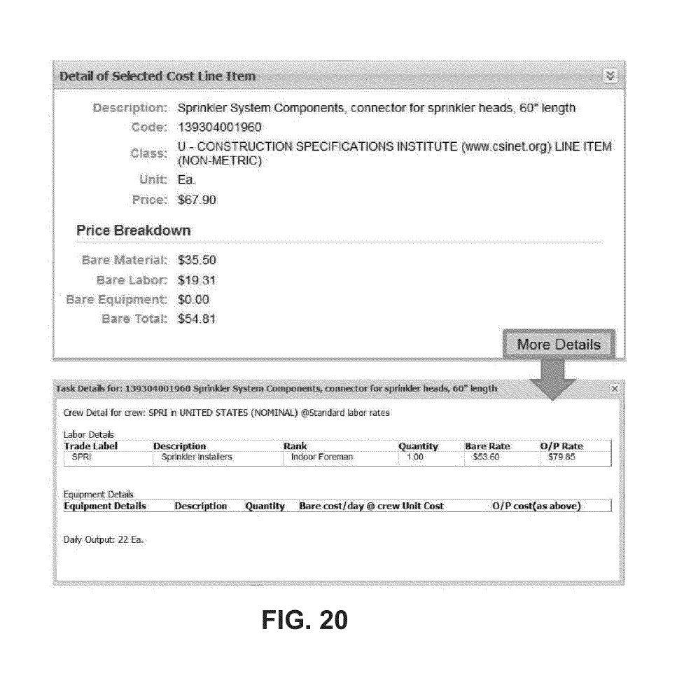

FIG. 20 is a screen shot of the cost estimator in which additional details for specific line item costs are listed. In this example, the action item is described as “Sprinkler System Components, connector for sprinkler head, 60″ length” including an item code, an item class, a unit and price for each. A price breakdown showing labor and materials costs are also individually shown. Finally, additional information labeled as “Task Details” is provided listing still more line item cost information. All of this provides a quick and easy means for a user to see cost information relating to various line items for the creation of action cost estimates.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A system for capital budgeting for real property comprising:
a computer having software executing thereon for generating a capital budgeting plan;
a storage accessible by said computer;
software executing on said computer providing a cost estimator for a user such that user is provided with a cost estimate for an action, said cost estimator including:
at least two cost databases, each database including cost information for performing an action item; and
wherein at least one of said at least two databases is selectable such that cost information is gather from the selected database to provide cost information for the action item.

2. The system according to claim 1 wherein the at least two cost databases correspond to different geographic areas.

3. The system according to claim 1 wherein the cost of the action item is based on the geographic location of the real property.

4. The system according to claim 1 wherein the at least two databases include cost information associated with the performance of the action item and/or groups of action items wherein the cost information includes labor costs and material costs.

5. The system according to claim 1 wherein said software presents a hierarchical listing of geographic locations and when one of the hierarchical listed locations is selected, labor costs and material costs information for the action item is reflective of the selected location.

6. The system according to claim 5, wherein the hierarchical listing of geographic locations comprises a tree of cost information in a first tier such that selection of one of the hierarchical listed locations in the first tier presents a hierarchical listing of geographic locations in a second tier as a sub category of the first tier.

7. The system according to claim 1 wherein said software presents a hierarchical listing of action items, which are saved in said storage, wherein each action item includes a code and a description such that each action item is searchable by either the code or the description.

8. The system according to claim 1 wherein said software presents a hierarchical listing of action items in a first frame, and when one of the hierarchical listed action items in a first frame is selected, information relating to the selected action item is presented in a second frame.

9. The system according to claim 8 wherein the information relating to the selected action item and presented in the second frame comprises line item cost information.

10. The system according to claim 8 wherein the information relating to the selected action item presented in a second frame comprises a hierarchical listing of action items, and when one of the hierarchical listed action items in the second frame is selected, information relating to the selected action item is presented in a third frame.

11. The system according to claim 10 wherein the information relating to the selected action item and presented in the third frame comprises line item cost information.

12. The system according to claim 1 wherein said software generates a report listing the action item and including cost information associated with the action item.

13. The system according to claim 12 wherein at least two action items are selected and said report includes a ranked list of the at least two action items including cost information for each action item.

14. The system according to claim 1 wherein when both of the at least two cost databases are selected, system separately lists costs associated with the action item from the plurality of databases.

15. The system according to claim 14 wherein the system provides an average of the costs associated with the action item from the at least two cost databases.

16. The system according to claim 1 wherein said computer includes a network connection and said cost estimator is presented to a user via a web page interface.
